(19) United States
(12) Patent Application Publication
(10) Pub. No.: US 2010/0084557 A1
(43) Pub. Date: Apr. 8, 2010

(54) LIGHT INTENSITY CONTROL FOR NEAR INFRARED SPECTROSCOPY

(75) Inventors: Phaik Sun Koay, Vancouver (CA); Qichao Zhu, Burnaby (CA); Luya Li, Coquitlam (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Urodynamix Technologies Ltd., Vancouver, BC (CA)

(21) Appl. No.: 12/598,419

(22) PCT Filed: May 1, 2008
(86) PCT No.: PCT/CA2008/000820

§ 371 Date: Oct. 30, 2009

Related U.S. Application Data
(60) Provisional application No. 60/915,402, filed on May 1, 2007.

(51) Int. Cl. G01J 3/02; G01J 5/02

(52) U.S. Cl. 250/339.07; 340/540

(57) ABSTRACT

A system for near infrared spectroscopy includes a controller that automates selection of light intensities for one or more light sources. The system may stepwise increase or decrease a current driving a light source until a signal received at a light detector is within a desired range. The system may maintain closed loop control over the intensity of a light source after the intensity has been set. The closed loop control may be based on a signal from a second light detector that senses light from the light source. Current/intensity settings may be established for each of multiple light detectors. In response to selection of a light detector, the corresponding current may be delivered to drive the light source.

### CROSS-REFERENCE TO RELATED APPLICATION

This application claims priority from U.S. patent application Ser. No. 60/915402 filed on 1 May 2007 and entitled LIGHT INTENSITY CONTROL FOR NEAR INFRARED SPECTROSCOPY. For purposes of the United States of America, this application claims the benefit under 35 U.S.C. §119 of U.S. patent application Ser. No. 60/915402 filed on 1 May 2007 and entitled LIGHT INTENSITY CONTROL FOR NEAR INFRARED SPECTROSCOPY which is hereby incorporated herein by reference.

### FIELD OF THE INVENTION

This invention relates to near infrared spectroscopy (NIRS). Embodiments provide apparatus and methods for measuring the concentrations of compounds (typically biological compounds) in the tissues of living subjects using NIRS.

### BACKGROUND

Near Infrared Spectroscopy (“NIRS”) is a technique which involves emitting near infrared (“NIR”) light and receiving the NIR light after it has passed through a tissue or other medium of interest. NIRS can be applied to study and monitor biochemical compounds in the body. Emitted NIR light penetrates skin and other tissues and some of it is absorbed by biochemical compounds which have an absorption spectrum in the NIR region. NIR light which is not absorbed is scattered. Each biochemical compound has a different absorption spectrum. It is possible to estimate the concentration of biochemical compounds in the tissues by measuring characteristics of NIR light that has been detected after it has passed through the tissues.

A typical NIRS apparatus emits light of a number of wavelengths (typically two or more wavelengths) and detects light after it has passed through tissues of a living subject. Since light detectors are only sensitive within a given range, it is necessary that the intensity of the light emitted be sufficient to be detected by the light detector. It is also necessary that the intensity of the light not be so great that it saturates the detector.

There is a need for cost-effective, simple to operate apparatus for performing NIRS on living subjects.

### BRIEF DESCRIPTION OF THE DRAWINGS

The appended drawings illustrate non-limiting example embodiments of the invention.

FIG. 1 is a block diagram illustrating a NIRS apparatus according to an embodiment of the invention.

FIG. 2 is a flowchart illustrating a method for operating NIRS apparatus according to an embodiment of the invention.

### DETAILED DESCRIPTION

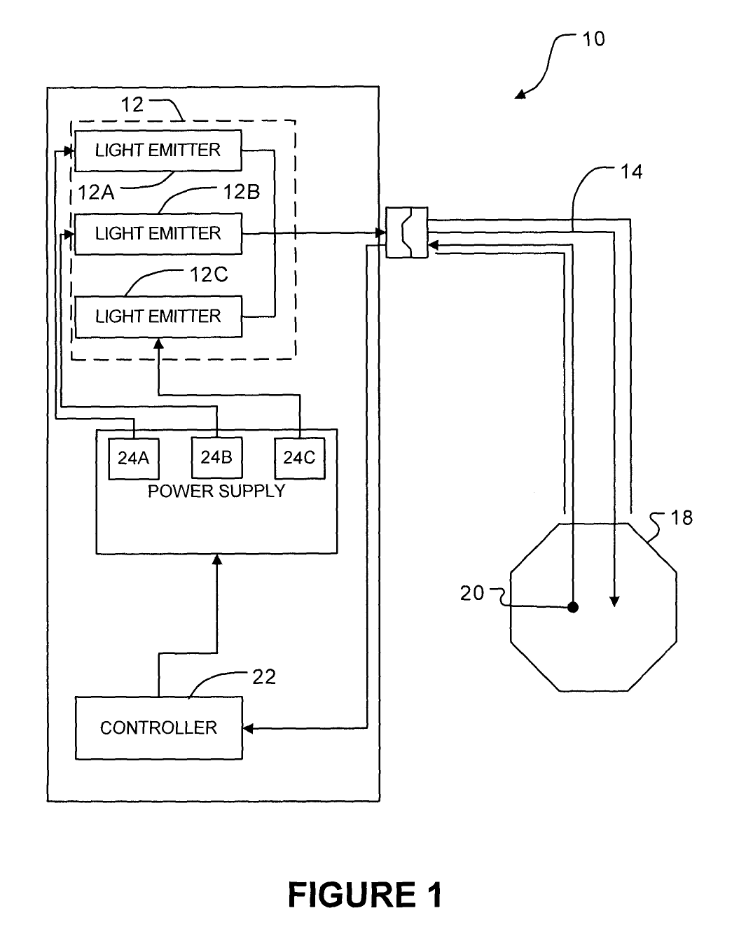

FIG. 1 shows apparatus 10 for practicing NIRS. Apparatus 10 has several light emitters 12 (individually labeled 12A, 12B and 12C). The number of light emitters may depend upon the intended application. Typically there will be two or three or four light emitters. Other numbers of light emitters are also possible. Some embodiments may provide five or more light emitters.

In some embodiments, light emitters 12 comprise solid state lasers (such as laser diodes) or high intensity light emitting diodes, or other light emitters that emit light having an appropriate wavelength. Light from light emitters 12 is carried by an optical fibre 14 or other light conduit to a probe or patch 18 which can be placed against the skin of a subject. Patch 18 also has disposed upon it one or more light detectors 20.

In operation, light is emitted by light sources 12. Each light emitter 12 emits light having a spectral character different from that of other light emitters 12. For example, each light emitter 12 may emit light within a narrow wavelength band that is different from that of other light emitters 12. Apparatus 10 can be made sensitive to changes in concentration of different compounds or other materials that interact differentially with light of different wavelengths. The wavelengths emitted by light emitters 12 are typically in the near-infrared portion of the spectrum (although the apparatus and methods described herein are not limited to any specific wavelengths or wavelength regions).

The light is carried by optical fibre 14 to patch 18 where it enters the tissues of a patient. Within the tissues of the patient the light is backscattered. Backscattered light is picked up by light detector(s) 20. Measuring the amount of backscattered light detected at detector 20 at various wavelengths permits changes in concentration of various biological compounds (and/or other materials present in the subjects' tissues) to be monitored.

It is desirable that the light output by each light emitter 12 have an intensity such that the backscattered (or transmitted) light emitted from that light emitter 12 and subsequently detected at detector 20 has an intensity in a portion of the range of detector 20 such that light detector 20 can detect changes in intensity of the backscattered (or transmitted) light and is not saturated.

The intensity of the detected light depends on a number of factors which may include:
the intensity of light emitted by a light emitter 12;
the length of the path taken by light from the emitter 12 through the subject's tissues to detector 20;
the sensitivity of detector 20 to light from the light emitter 12;
the nature of the tissues through which the light propagates; and,
the efficiency of any optical paths or devices which transmit light from light emitter 12 to the subject and from the subject to light detector 20.

Apparatus 10 comprises a controller 22 which adjusts the output of each light emitter 12 in such a manner that the backscattered light detected at light detector 20 is within this desired range of operation, preferably somewhere near the center of the range of light intensities to which light detector 20 is sensitive. Since light detector 20 may have a sensitivity that is wavelength dependent, the desired intensity may be different for each light emitter 12.

Controller 22 controls current sources 24A, 24B and 24C (shown as individually-controllable outputs of a power supply 25 in the illustrated embodiment) which regulate the current supplied to each of light emitters 12A, 12B and 12C respectively.

Controller 22 may comprise:
a programmable controller, such as a digital signal processor, micro-processor, or the like;
logic circuits provided by a field programmable gate array (FPGA), a set of discreet logic circuits, an application specific integrated circuit (ASIC) or the like;
a combination thereof.

Controller 22 has a calibration mode wherein it adjusts the outputs of light emitters 12 (i.e. the intensity of emitted light) in response to measurements of the light detected at light detector 20. The outputs of light emitters 12 may be varied by varying the electrical current driving each light emitter 12 in some embodiments. Controller 22 varies the light output of each light emitter 12 (for example by adjusting the driving current) until the light detected at light detector 20 is in a suitable portion of the range of light detector 20.

If controller 22 completes its calibration sequence without being able to set the current driving a light source to a value which will result in the light source having a desired intensity then controller 22 may signal an alarm condition, for example by displaying a trouble light, a trouble message on a user interface, signaling an audible alarm, or the like.

In typical embodiments, during operation, each light emitter 12 is pulsed. For example, each light emitter may be operated to emit a pulse of light a few milliseconds or microseconds long. Light emitters 12 may be operated such that only one light emitter 12 is operating at any given time. This permits the variation in the amount of backscattered light at the wavelength of each light emitter 12 to be independently determined. In alternative embodiments, two or more light emitters 12 may be operated simultaneously, but in different combinations at different times, to permit variations in the amount of light backscattered at each of a plurality of wavelengths to be determined.

In the calibration mode, each light emitter 12 may be pulsed at a current level set by the corresponding current supply 24 under control of controller 22. Controller 22 can determine from the intensity of light detected by light detector 20 at the instant the light emitter 12 is pulsed, whether or not a signal can be detected that corresponds to light being backscattered from light emitter 12 and also, whether or not that backscattered light has an intensity suitable to cause the detected signal to have a level within the desired range. If the backscattered light is too bright then controller 22 may reduce the current driving the light emitter 12 until the backscattered light has an intensity within a desired range. If the backscattered light is too dim, then controller 22 may increase the driving current of the light emitter 12 until the backscattered light is within the desired range. Adjustments to the current driving each light source 12 may be made in a step wise manner during calibration.

In some embodiments, the size of the steps is varied, depending upon how different the light intensity detected at detector 20 is from the desirable light intensity. If the intensity of light detected at light detector 20 is very much greater or less than the desired light intensity then the current driving the light emitter 12 may be varied in relatively large steps. If the intensity detected at light detector 20 is not optimum but is fairly close to the optimum light intensity then the current driving the corresponding light emitter 12 may be adjusted in smaller steps.

After each light emitter 12 has been adjusted so that backscattered light can be detected successfully at light detector 20 within a desired part of the range of light detector 20 then the current supplied to each of the light emitters 12 may be controlled to keep the current for each light emitter 12 (and therefore the intensity of light emitted by each light emitter 12) at the optimum value.

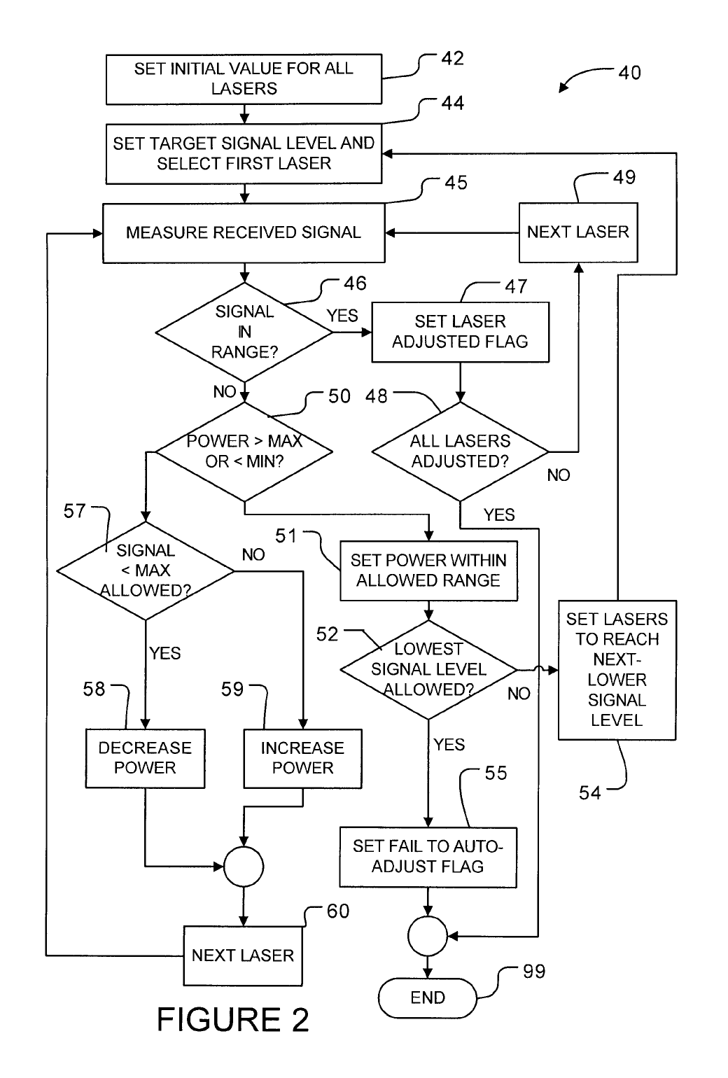

FIG. 2 shows a method 40 according to an example embodiment of the invention. Method 40 may be implemented in a data processor or other programmable advice by providing instructions which are executed by the programable device to cause it to execute method 40.

In block 42, an initial starting current is set for each light emitter 12. This initial value may be approximately at the threshold current for operating each light emitter 12. In block 44, an appropriate target signal level is set and one of light emitters 12 is selected for initial adjustment. In block 45, the selected light emitter is operated with a current at the initial value and the resulting signal received at light detector 20 is measured.

In block 46, a determination is made as to whether a signal detected is within the desired range. If there is a “yes” result in block 46 then a flag is set in block 47 to indicate that the selected light emitter 12 has been adjusted. Block 48 then determines if all light emitters 12 have been adjusted. In the event of a “no” result in block 48 then the next light emitter 12 is selected in block 49 and method 40 returns to block 45 where the next light emitter 12 is selected.

In the event of a “yes” result in block 48, all light emitters 12 have been adjusted and method 40 ends at block 99.

In the even of a “no” result in block 46, block 50 determines whether the current selected for the current light emitter 12 has a value that is outside of an allowable current range. If so then, in block 51, the current driving the selected light emitter 12 is brought back into the allowable range and in block 52 the target signal level is evaluated to determine whether it could be reduced. If there exists an allowable target signal level lower than the existing target signal level then, in block 54, the target signal level is set to the lower value and control returns to block 44. If there is no lower signal level allowed then in block 55, a flag is set indicating that it was not possible to achieve suitable signal levels and method 40 terminates at block 99.

In the event of a “no” result at block 50, then block 57 determines whether or not the detected signal is less than the maximum allowable detected signal. If yes, then the driving current for the current light emitter 12 is decreased in block 58. If no, then the driving current for the current light emitter 12 is increased in block 59. In block 60, method 40 selects the next light emitter 12 and returns to block 45 for further processing.

It can be appreciated that, in some embodiments at least, the methods and apparatus of this invention are advantageous because they automatically take into account differences in the sensitivity of light detector(s) 20 to different wavelengths of light.

In some embodiments, after the desired intensity of each light emitter 12 has been determined, the light output of each light emitter 12 is controlled with reference to a signal from a separate light detector (not shown) that directly detects the light emitted from the light emitter 12 before that light passes through tissues of a subject. The light intensity of each light emitter 12 may be controlled in a closed-loop control.

Separate calibrations may be provided for each of a number of different light detectors 20 located at different locations to detect light that has been backscattered by a section of tissue and/or has passed through the section of tissue. Controller 22 may be programmed or otherwise configured to apply different driving currents to light sources 12 depending upon which light detector 20 is being monitored. For example, there may be ten different light detectors 20 at different distances from or different positions relative to the point at which light is emitted into the subject from optical fibre 14. A different set of driving current values (or other intensity-determining values) may be determined for each light detector 20. Controller 22 may select a set of current values corresponding to a particular light detector 20 and then operate the light emitters 12 with those current values while monitoring the light detector 20 and then repeat the procedure for other light detectors 20.

While a number of exemplary aspects and embodiments have been discussed above, those of skill in the art will recognize certain modifications, permutations, additions and sub-combinations thereof. For example:
Light detected at light detector 20 is not necessarily backscattered light. The light may be detected after passing through a section of tissue in a forward direction.
Light detector 20 is not necessarily mounted on patch 18. Light detector 20 could be located remotely from patch 18. Light detector 20 could be provided on a separate probe or patch from patch 18 or light could be carried to light detector 20 by an optical fiber or other optical conduit extending from patch 18 to light detector 20.

Certain implementations of the invention comprise computer processors which execute software instructions which cause the processors to perform a method of the invention. For example, one or more processors in a NIRS apparatus may implement the methods of the invention by executing software instructions in a program memory accessible to the processors. The invention may also be provided in the form of a program product. The program product may comprise any medium which carries a set of computer-readable signals comprising instructions which, when executed by a computer processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be encoded, compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

1. Apparatus for near infrared spectroscopy (NIRS) comprising:
a light source;
at least one first light detector positionable to detect light from the light source after the light has passed through tissues of a subject;
a controller connected to receive an output signal from the first light detector and configured to set an intensity of light emitted by the light source based at least in part on the output signal from the first light detector to cause the output signal from the first light detector to be in a predetermined range.

2. Apparatus according to claim 1 wherein the light source comprises a solid-state light source.

3. Apparatus according to claim 2 wherein the solid-state light source comprises a laser diode.

4. Apparatus according to claim 1 wherein the controller is configured to stepwise increase an electrical current drawn by the light source in response to determining that the output signal from the first light detector is below a lower threshold.

5. Apparatus according to claim 4 wherein the controller is configured to stepwise decrease an electrical current drawn by the light source in response to determining that the output signal from the first light detector is above an upper threshold.

6. Apparatus according to claim 4 wherein the controller is configured to set a step-size for the stepwise increase of electrical current based at least in part on a difference between the output signal from the first light detector and a desired output signal value.

7. Apparatus according to claim 5 wherein the controller is configured to set a step-size for the stepwise decrease of electrical current based at least in part on a difference between the output signal from the first light detector and a desired output signal value.

8. Apparatus according to claim 1 wherein the light source constitutes a first one of a plurality of light sources and the controller is configured to independently set the intensity for each one of the plurality of light sources.

9. Apparatus according to claim 8 wherein each of the plurality of light sources is capable of emitting light having spectral characteristics distinct from spectral characteristics of at least one other one of the plurality of light sources and the first light detector has different sensitivities to the light emitted by different ones of the light sources.

10. Apparatus according to claim 8 wherein the controller is configured to sequentially set the light output for each of the plurality of light sources.

11. Apparatus according to claim 8 wherein the controller is configured to: operate light sources of the plurality of light sources in a plurality of different combinations; determine a value for the output signal from the first light detector corresponding to each one of the different combinations; and, set the intensity of the first one of a plurality of light sources based upon the values for the output signal corresponding to a plurality of the combinations.

12. Apparatus according to claim 8 comprising a control configured to regulate current drawn by each of the plurality of light sources to have a value corresponding to the intensity set by the controller for the light source.

13. Apparatus according to claim 12 wherein the control comprises a closed-loop control.

14. Apparatus according to claim 13 comprising one or more second light detectors positioned to receive light emitted by light sources of the plurality of light sources wherein the closed-loop control controls the current drawn by each of the plurality of light sources in response to a signal from the second light detectors.

15. Apparatus according to claim 1 wherein the controller is configured to generate an alarm indication in the event that the controller fails to cause the output signal from the first light detector to be in a predetermined range after a predetermined number of attempts.

16. Apparatus according to claim 1 comprising a second light detector located to detect light emitted by the light source.

17. Apparatus according to claim 16 comprising a closed-loop control set to control a light output of the light source to have the intensity set by the controller in response to a signal from the second light detector.

18. Apparatus according to claim 1 wherein the controller comprises a programmed data processor.

19. Apparatus according to claim 1 comprising a plurality of first light detectors wherein the controller is configured to determine and store information specifying a set light intensity for the light source corresponding to each of the plurality of first light detectors.

20. An automated method for set up of apparatus for near infrared spectroscopy (NIRS) comprising a solid-state light source and a first light detector positionable to detect light from the light source after the light has passed through tissues of a subject, the method comprising the steps of:
(a) setting a current drawn by the solid-state light source to an initial value;
(b) comparing an output signal of the light detector to a desired range;
(c) if the output signal is outside of the desired range stepwise increasing or decreasing the current to cause the light output to approach the desired range; and,
(d) repeating steps (b) and (c) until the output signal is within the desired range or a termination condition is satisfied.

21. A method according to claim 20 comprising repeating the method for each one of a plurality of different solid-state light sources.

22. A method according to claim 20 comprising setting a step size for step (c) based at least in part upon a difference between the output signal and a desired value for the output signal.

23. A method according claim 20 wherein the first light detector constitutes one of a plurality of first light detectors wherein the method comprises repeating the method for each one of the plurality of first light detectors.

24. A method according to claim 23 comprising, for at least one of the plurality of first light detectors storing information specifying a current for the first light source.

25. A method according to claim 24 comprising, upon selection of the one of the plurality of first light detectors, retrieving the information specifying a current for the first light source and controlling the current to the first light source according to the specified current.

26. A method according to claim 20 comprising operating the light source while maintaining closed loop control of current to the light source.

27. A method according to claim 26 wherein maintaining closed loop control of current to the light source comprises monitoring an intensity of light output by the solid-state light source by way of a second light sensor and controlling the current to the solid-state light source based on an output from the second light sensor.

28-29. (canceled)
